(19) United States
(12) Patent Application Publication
(10) Pub. No.: US 2015/0301337 A1
(43) Pub. Date: Oct. 22, 2015

(54) HMD DEVICE PROVIDING NOTIFICATION AND METHOD OF CONTROLLING THEREFOR

(71) Applicant: LG ELECTRONICS INC., Seoul (KR)

(72) Inventors: Sihwa PARK, Seoul (KR); Yongsin KIM, Seoul (KR); Jihwan KIM, Seoul (KR)

(73) Assignee: LG ELECTRONICS INC., Seoul (KR)

(21) Appl. No.: 14/285,959

(22) Filed: May 23, 2014

(30) Foreign Application Priority Data
Apr. 16, 2014 (KR) 10-2014-0045270

(51) Int. Cl. G02B 27/01; G06F 3/01

(52) U.S. Cl. CPC G02B 27/0172; G06F 3/013

(57) ABSTRACT

The present specification relates to a HMD device providing a notification and a method of controlling therefor. According to one embodiment, the method includes the steps of setting a sleep event, wherein if a sleep signal is obtained, the sleep event is set in the HMD device and wherein the sleep event indicates that a user of the HMD device is in a sleeping state, receiving first location information, obtaining a sleep event release signal, receiving second location information, wherein movement information of the HMD device of the first location information is reflected on the second location information and providing a notification on the second location information of the HMD device.

This application claims the benefit of the Korean Patent Application No. 10-2014-0045270, filed on Apr. 16, 2014, which is hereby incorporated by reference as if fully set forth herein.

### BACKGROUND OF THE INVENTION

1. Field of the Invention

The present specification relates to a HMD device providing a notification and a method of controlling therefor.

2. Discussion of the Related Art

As a head mounted display (hereinafter abbreviated HMD) device is lightened, a user can wear the HMD device like glasses. The user can carry the HMD device like a mobile device. In particular, the user may have a daily life while wearing the HMD device. In this case, the HMD device can provide various informations to the user for the convenience of the user. As an example, the HMD device can enable the user to easily check information on a real object in a manner of providing the real object and an augmented reality object. As mentioned in the foregoing description, the HMD device can be carried by the user and can provide various informations to the user.

A user wearing the HMD device may use a means of transportation. A location of the user may change due to a movement of the means of transportation. In this case, the HMD device can provide location information to the user. More specifically, the HMD device can receive the location information of the user wearing the HMD device using a location information receiving unit. In this case, unlike a mobile device, since the HMD device is used in a manner of being worn by the user, the HMD device can precisely provide the location information of the user. And, the HMD device can provide the location information in consideration of a body condition and a status of the user wearing the HMD device. To this end, it is necessary to have a detail method of providing the location information in consideration of a body condition and a status of the user wearing the HMD device.

### SUMMARY OF THE INVENTION

Accordingly, the present specification is directed to an apparatus and method thereof that substantially obviate one or more problems due to limitations and disadvantages of the related art.

The present specification relates to a HMD device providing a notification and a method of controlling therefor.

An object of the present specification is to provide a method for the HMD device to detect a release of a sleeping state of a user and provide a notification on location information of the user when the sleeping state is released.

Another object of the present specification is to provide a method for the HMD device to detect a gaze of a user and determine whether the user is in a sleeping state in consideration of whether the gaze of the user is blocked.

Another object of the present specification is to provide a method for the HMD device to detect a bio-signal of a user and determine whether the user is in a sleeping state by analyzing the bio-signal of the user.

Another object of the present specification is to provide a method for the HMD device to periodically receive location information using a location information receiving unit.

The other object of the present specification is to provide a method for the HMD device to provide a notification to a user using visual information or audio information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a HMD device can include a sensor unit configured to detect an input signal and deliver the detected input signal to a processor, a location information receiving unit configured to receive location information, the location information receiving unit configured to receive first location information of the HMD at a specific point before a sleep event release signal is obtained, the location information receiving unit configured to receive a second location information of the HMD device at a specific point within a threshold time after the sleep event release signal is obtained, wherein movement information of the HMD device of the first location information is reflected on the second location information, and the processor configured to control the location information receiving unit and the sensor unit, if a sleep signal is obtained, the processor configured to set a sleep event in the HMD device, wherein the sleep event indicates that a user of the HMD device is in a sleeping state, if the sleep event release signal is obtained while the sleep event is set, the processor configured to provide a notification on the second location information of the HMD device.

Accordingly, the present specification provides the following effects or advantages.

According to the present specification, it may provide a HMD device providing a notification and a method of controlling therefor.

According to the present specification, it may provide a method for the HMD device to detect a gaze of a user and determine whether the user is in a sleeping state in consideration of whether the gaze of the user is blocked.

According to the present specification, it may provide a method for the HMD device to detect a bio-signal of a user and determine whether the user is in a sleeping state by analyzing the bio-signal of the user.

According to the present specification, it may provide a method for the HMD device to periodically receive location information using a location information receiving unit.

According to the present specification, it may provide a method for the HMD device to provide a notification to a user using visual information or audio information.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram for a HMD device according to one embodiment of the present specification;

FIG. 2 is a diagram of a method for a user to check a current location in case that the user moves according to one embodiment of the present specification;

FIG. 3a and FIG. 3b are diagrams of a method for a HMD device to provide a notification on location information to a user according to one embodiment of the present specification;

FIG. 4a and FIG. 4b are diagrams of a method for a HMD device to receive location information according to one embodiment of the present specification;

FIG. 5a and FIG. 5b are diagrams of a method for a HMD device to provide a notification according to one embodiment of the present specification;

FIG. 6 is a diagram of a method for a HMD device to provide an alarm for a destination to a user according to one embodiment of the present specification;

FIG. 7a and FIG. 7b are diagrams of a method for a HMD device to provide a notification prior to a different content according to one embodiment of the present specification;

FIG. 8a and FIG. 8b are diagrams of a method for a HMD device to provide a notification based on a transportation means used by a user according to one embodiment of the present specification;

FIG. 9 is a flowchart of a controlling method for a HMD device to set a sleep event according to one embodiment of the present specification;

FIG. 10 is a flowchart of a controlling method for a HMD device to provide a notification on location information according to one embodiment of the present specification;

### DETAILED DESCRIPTION OF THE INVENTION

While embodiments have been described in detail with reference to the attached drawings and contents written on the drawings, the scope of claims may be non-restricted or non-limited by the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

A HMD device 100 may indicate a wearable device capable of providing various information to a user in a manner of being worn on the user in the present specification. In this case, as an example, the HMD device 100 can provide visual information, audio information or the like to the user in a manner of being worn on the user like glasses. And, as an example, the HMD device 100 may correspond to a device capable of being used in a manner of being worn on a different part of a body of the user. And, the HMD device 100 may correspond to a mobile device capable of being carried by the user. The present specification may be non-limited by the aforementioned embodiment.

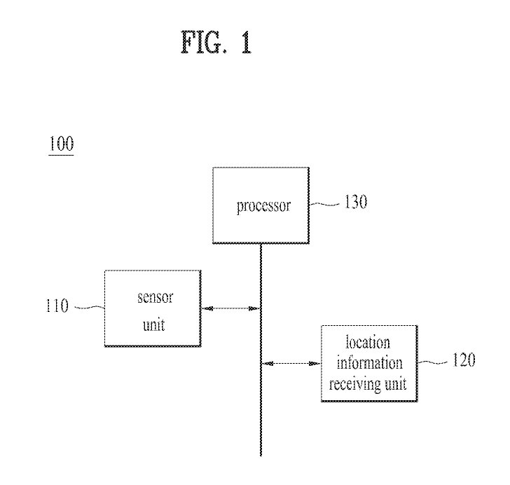

FIG. 1 is a block diagram for a HMD device 100 according to one embodiment of the present specification. The HMD device 100 can include a sensor unit 110, a location information receiving unit 120 and a processor 130.

The sensor unit 110 detects an input signal and can deliver the detected input signal to the processor 130. More specifically, the sensor unit 110 detects a control input controlling the HMD device 100 and can deliver the detected control input to the processor 130.

In this case, as an example, the input signal may include at least one selected from the group consisting of a gaze of a user, a rotating motion of a head of the user and a bio-signal of the user. In particular, the sensor unit 110 can detect a body condition of the user or a signal capable of being sensed from the user as the input signal, by which the present specification may be non-limited. More specifically, the sensor unit 110 can detect a gaze of the user as the input signal. And, the sensor unit 110 can deliver the input signal for the gaze of the user to the processor 130. The processor 130 can control the HMD device 100 using the delivered input signal. In particular, the input signal may correspond to a signal sensed by using the sensor unit 110. The sensor unit 110 may deliver the sensed signal to the processor.

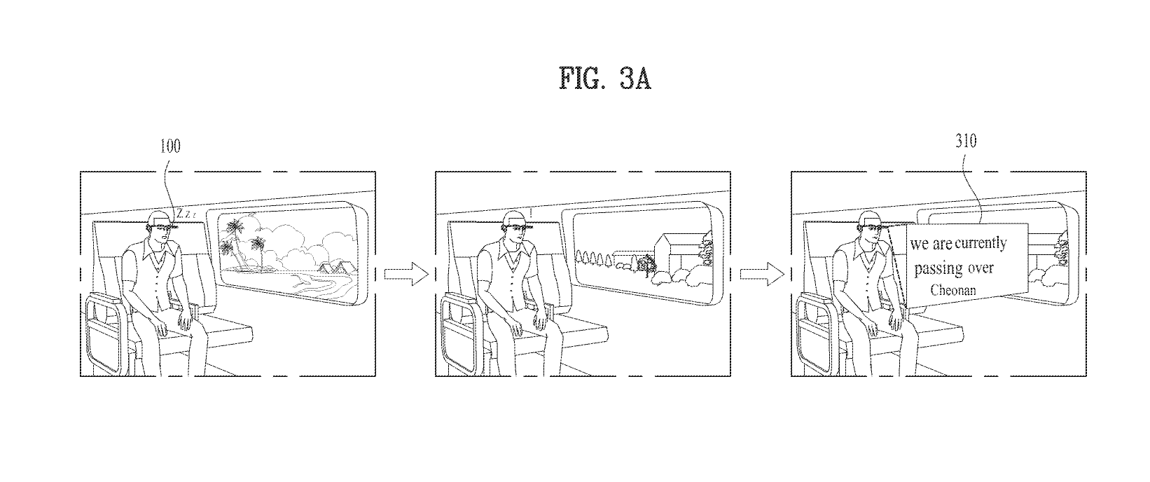

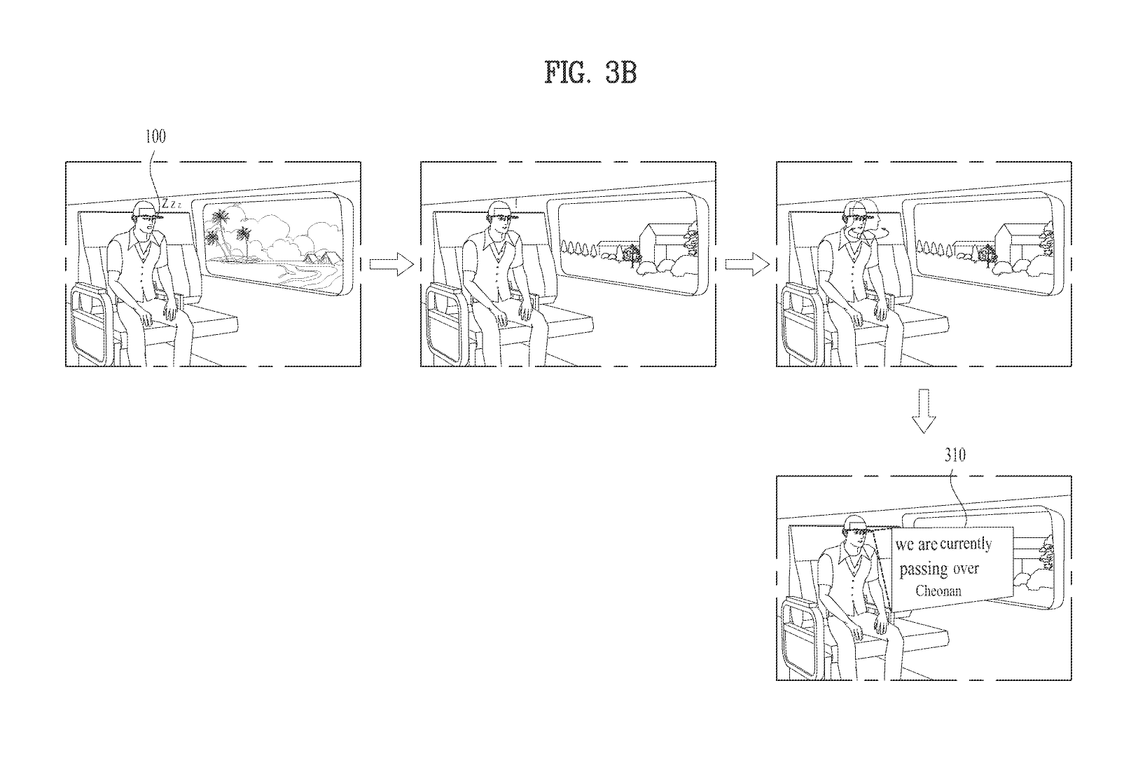

By doing so, the sensor unit 110 can detect that a sleeping state of the user is released. Regarding this, it shall be described with reference to FIG. 3a and FIG. 3b.

And, the sensor unit 110 can detect a rotating motion of a head of the user. In this case, the sensor unit 110 can detect that the head of the user, who is wearing the HMD device 100 like glasses, is rotating.

And, as an example, the sensor unit 110 can detect one of a touch input, a tilt of the HMD device, an input device input, a voice input and a gesture input as an input signal.

And, as an example, the sensor unit 110 can detect various control inputs using at least one selected from the group consisting of a touch sensor, a gyro sensor, an acceleration sensor, an image sensor and a voice recognition sensor, by which the present specification may be non-limited. The sensor unit 110 delivers a detected input signal to the processor and the processor can control the HMD device 100 using the delivered input signal.

The location information receiving unit 120 can receive location information of the HMD device 100. In this case, as an example, the location information receiving unit 120 may include a GPS and can receive the location information of the HMD device 100 via a satellite. And, the location information receiving unit 120 may correspond to a unit receiving the location information of the HMD device 100 using a local area network or base station information. In particular, the location information receiving unit 120 may correspond to a unit receiving the location information of the HMD device 100, by which the present specification may be non-limited.

In this case, the location information receiving unit 120 can periodically receive the location information of the HMD device 100. More specifically, the location information receiving unit 120 can periodically receive and obtain the location information of the HMD device 100. In this case, the HMD device 100 can store the periodically obtained location information of the HMD device 100 as history information. By doing so, the location information receiving unit 120 periodically detects a location change of the HMD device 100 and can store detected location information as a data. And, as an example, the location information receiving unit 120 can receive the location information of the FIND device 100 based on a command of a user or a predetermined command of the processor. More specifically, the location information receiving unit 120 can receive the location information when the predetermined command exists only. By doing so, power consumption of the HMD device 100 can be reduced.

The location information receiving unit 120 can receive location information utilized by the HMD device 100, by which the present specification may be non-limited.

The processor 130 sets a sleep event in the HMD device 100. If the sleep event is released, the processor can provide a notification on location information to a user. In this case, the sleep event may correspond to an event indicating that the user is in a sleeping state. In particular, the sleep event can be configured on a timing that a state of the user is switched to the sleeping state and the sleep event can be maintained if the user maintains the sleeping state.

The sensor unit 110 can detect whether a user is in the sleeping state. In this case, if the user switches to the sleeping state, the processor 130 can obtain a sleep signal. And, if the sleeping state of the user is released, the processor 130 can obtain a sleep event release signal.

The sleep signal may correspond to a signal indicating that the user is switching to the sleeping state. As an example, the sensor unit 110 can detect a gaze of the user. In this case, the sensor unit 110 can detect that the detected gaze of the user is blocked for more than a predetermined threshold time. The processor 130 can obtain the sleep signal based on the detected sensing information. More specifically, the user is closing eyes in the sleeping state. Hence, if the detected gaze of the user is blocked for more than the threshold time, the sensor unit 110 can sense it as the user has switched to the sleeping state. The processor 130 can obtain the sleep signal based on the aforementioned sensing information. In this case, the threshold time may correspond to a threshold time used for determining whether the user is switched to the sleeping state and may have a prescribed error range. And, the threshold time can be adjusted by the user or the processor 130. And, the sensor unit 110 can detect the gaze of the user, which is blocked in the sleep event, again. The processor 130 can obtain the sleep event release signal based on the sensed information. In this case, the sleep event may correspond to an event indicating that the user is in the sleeping state. More specifically, the sensor unit 110 can detect that the gaze of the user is consistently blocked. If the gaze of the user is consistently blocked, the processor 130 can maintain the sleep event. If the sleeping state of the user is released and the user opens eyes again, the sensor unit 110 can detect the blocked gaze of the user again. The processor 130 can obtain the sleep event release signal based on the detected gaze of the user.

And, as an example, the sensor unit 110 can detect whether the HMD device 100 is worn by the user. And, the sensor unit 110 can detect a bio-signal of the user wearing the HMD device 100. In this case, the bio-signal may correspond to a brainwave, a heart rate, or the like. The bio-signal may correspond to a signal capable of checking the sleeping state of the user. The sensor unit 110 can detect whether the bio-signal of the user wearing the HMD device 100 is matched with a bio-sleeping signal. In this case, the bio-sleeping signal may correspond to a bio-signal when the user is in the sleeping state. The bio-sleeping signal may correspond to a predetermined value and can be configured by the user, by which the present specification may be non-limited. The sensor unit 110 can detect whether the bio-signal of the user wearing the HMD device 100 is matched with the bio-sleeping signal. In this case, the processor 130 can obtain the sleep signal. And, the sensor unit 110 can detect that the bio-signal of the user wearing the HMD device 100 is not matched with the bio-sleeping signal. In this case, the processor 130 can obtain the sleep event release signal. In particular, the sensor unit 110 detects whether the user is in the sleeping state and the processor 130 can control the sleep event based on the information sensed by the sensor unit 110.

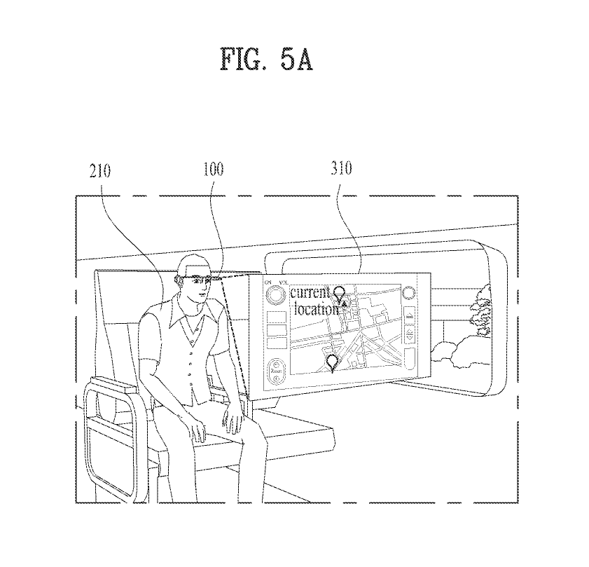

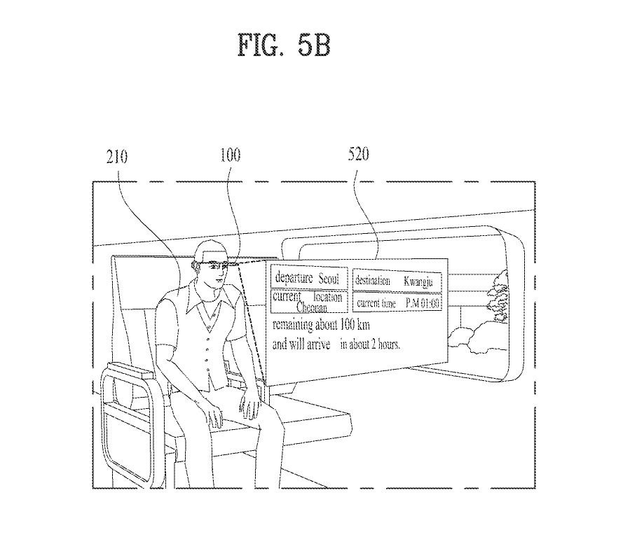

The processor 130 can provide a notification on location information to the user when the sleep event release signal is obtained. By doing so, if the sleeping state of the user is released, the HMD device 100 can provide a current location of the user to the user. In this case, the notification may correspond to information provided to the user by the HMD device 100. Regarding this, it shall be described later with reference to FIG. 5a and FIG. 5b.

And, the aforementioned elements are included in the HMD device 100 as a separate element or may be included in the HMD device in a manner of being integrated into at least one element.

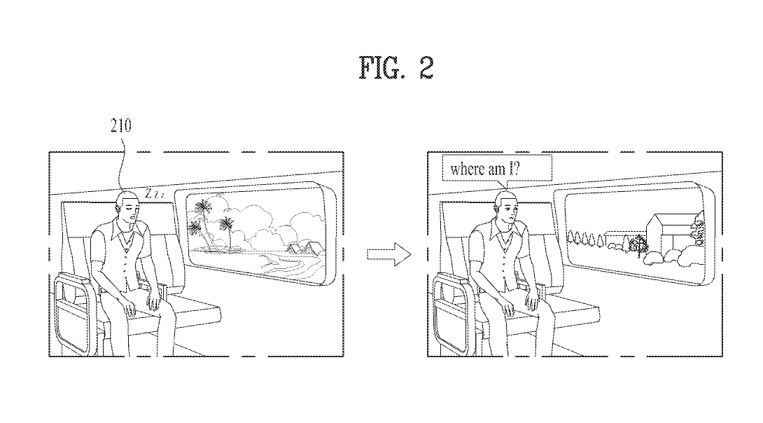

FIG. 2 is a diagram of a method for a user to check a current location in case that the user moves according to one embodiment of the present specification.

A user 210 can move using a transportation means. In this case, the transportation means may correspond to a subway, a train, a bus, a plane, by which the present specification may be non-limited. In this case, the user 210 may fall asleep while moving using the transportation means. When the user 210 fall asleep in the transportation means, the user 210 may pass by a destination. And, when the user 210 wakes up in the middle of sleeping in the transportation means, the user 210 may be difficult to find out where a current location of the user is. More specifically, in case of using the transportation means, the user can check the current location of the user using such a separate device as a mobile device carried by the user 210 when the sleeping state of the user is released. In this case, the user needs to perform an additional operation to check the current location. Hence, there may exist inconvenience in that the user cannot immediately know the current location of the user after waking up from the sleeping state.

FIG. 3a and FIG. 3b are diagrams of a method for a HMD device to provide a notification on location information to a user according to one embodiment of the present specification.

A user can use a transportation means while wearing the HMD device 100. In this case, as mentioned in the foregoing description, the HMD device 100 can check a sleeping state of the user. More specifically, when the user wearing the HMD 100 uses the transportation means, the HMD device 100 can check whether the user is in the sleeping state. As an example, as mentioned in the foregoing description, the HMD device 100 can check the sleeping state of the user using a gaze of the user or a bio-signal of the user. The HMD device 100 can detect that the user wearing the HMD device 100 is switched to the sleeping state while using the transportation means. As an example, the HMD device 100 detects a gaze of the user. If the HMD device detects that the detected gaze of the user is blocked for more than a threshold time, the HMD device can detect that the user is switched to the sleeping state. And, as an example, the HMD device 100 can detect a bio-signal of the user. If the detected bio-signal of the user is matched with a predetermined bio-sleeping signal, the HMD device can detect that the user is switched to the sleeping state. In this case, the HMD device 100 can obtain a sleep signal. If the HMD device 100 obtains the sleep signal, a sleep event can be set in the HMD device 100. The sleep event may correspond to an event indicating that the user is in the sleeping state. In this case, if the user maintains the sleeping state, the HMD device 100 can maintain the sleep event. As an example, if a state that the gaze of the user is blocked is maintained, the HMD device 100 can maintain the sleep event. As a different example, the HMD device 100 can maintain the sleep event as long as the bio-signal of the user is matched with the bio-sleeping signal.

And, if the sleeping state of the user is released, the HMD device 100 can obtain a sleep event release signal. In this case, as an example, if the HMD device 100 detects that the blocked state of the gaze of the user is released, the HMD device can obtain the sleep event release signal. And, the HMD device 100 can obtain the sleep event release signal when the user opens eyes and an additional operation of the user is detected only. As an example, the HMD device 100 can obtain the sleep event release signal when the blocked state of the gaze of the user is released and a rotating motion of a head of the user is further detected. More specifically, if the HMD device 100 detects the gaze of the user again and rotation of the head of the user, which is rotating more than an angle threshold on the basis of a rotating axis, the HMD device can obtain the sleep event release signal. In this case, the rotating motion of the head of the user may correspond to an operation that the user rotates the head of the user. And, the rotating axis can be configured on the basis of a center of the head of the user. In particular, the HMD device 100 detects a rotation angle of the head of the user wearing the HMD device 100 and can determine whether the detected angle is greater than the angle threshold. By doing so, the HMD device 100 can check that the user is released from the sleeping state.

Besides, an additional operation of the user, which is necessary for the HMD device 100 to obtain the sleep event release signal, can be configured by the user or the HMD device 100, by which the present specification may be non-limited.

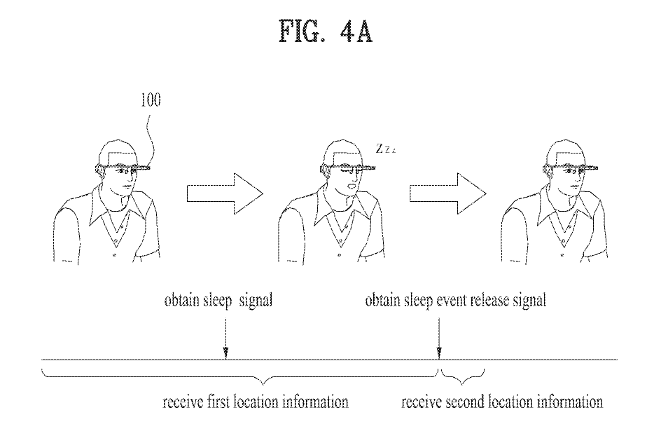

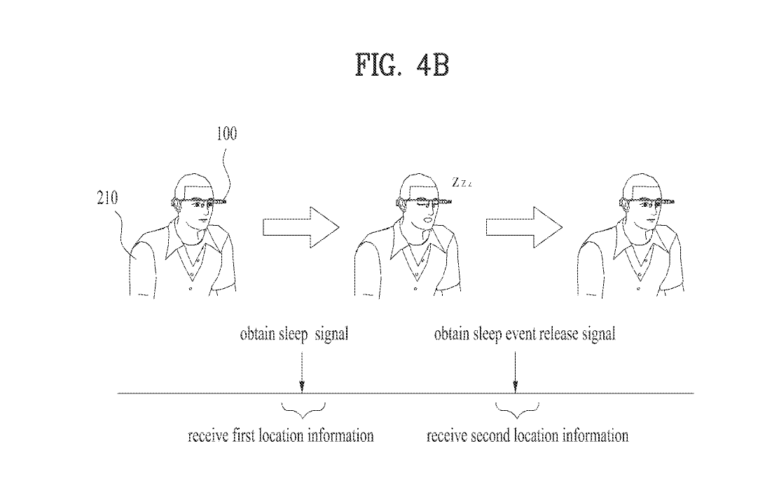

In case of obtaining the sleep event release signal by the HMD device 100 in a sleep event state, the HMD device 100 can obtain location information within a threshold time when the HMD device 100 obtains the sleep event release signal. Regarding this, it shall be described later with reference to FIG. 4a and FIG. 4b.

In case of obtaining the sleep event release signal by the HMD device 100 in the sleep event state, the HMD device 100 can provide a notification on the aforementioned location information to the user. In this case, the HMD device 100 can provide the notification to the user using visual information. And, the HMD device 100 can provide the notification to the user using audio information. More specifically, the HMD device 100 can include a display unit (not depicted) providing visual information. Having received the sleep event release signal, the HMD device 100 can provide the location information as visual information using the display unit. In this case, the visual information may correspond to text information or image information, by which the present specification may be non-limited. In particular, if the user is released from the sleeping state, the HMD device 100 can provide current location information as visual information.

And, as an example, the HMD device 100 can include an audio unit (not depicted) outputting audio information. The HMD device 100 can provide the location information as audio information using the audio unit.

And, as an example, the HMD device 100 can provide the notification on the location information to the user when the user is not in the sleeping state as well. More specifically, if the HMD device 100 detects an input signal for providing the notification, the HMD device 100 can provide the notification to the user. In this case, the input signal may correspond to an input which is inputted based on a touch input, a gesture input, an input inputted by an input device, or an operation of the user, by which the present specification may be non-limited. As an example, if the user is not in the sleeping state, the HMD device can detect a rotating motion of the head of the user as the input signal. In this case, the HMD device 100 can detect whether the user rotates the head of the user more than an angle threshold on the basis of a rotating axis. In this case, as mentioned in the foregoing description, the rotating axis may correspond to a center of the head of the user and the angle threshold may correspond to a value configured by the user or the HMD device 100. The HMD device 100 utilizes the rotation motion as a control input for providing a notification and can provide the notification to the user. And, as an example, the HMD device 100 can detect a gesture operation of the user. In this case, if the HMD device 100 detects a predetermined gesture operation, the HMD device 100 can utilize the predetermined gesture operation as the control input for providing the notification. In particular, the HMD device 100 can provide the notification based on a predetermined input signal although the HMD device 100 does not detect the sleeping state of the user, by which the present specification may be non-limited.

FIG. 4a and FIG. 4b are diagrams of a method for a HMD device to receive location information according to one embodiment of the present specification.

The HMD device 100 can receive location information of the HMD 100 using the location information receiving unit 120. In this case, the location information may correspond to location information which is changed according to a movement of the user wearing the HMD device 100. More specifically, the HMD device 100 can provide information, which is moved via a transportation means while a user 210 is in a sleeping state, to the user as the location information. By doing so, the user 210 can check the location information when the sleeping state of the user is released.

In this case, the HMD device 100 can receive a first location information of the HMD device 100 at a specific point before a sleep event release signal is obtained. Subsequently, the HMD device 100 can receive a second location information of the HMD device 100 at a specific point within a threshold time after the sleep event release signal is obtained. And, as an example, the HMD device 100 can receive the second location information of the HMD device 100 at a specific point within the threshold time before the sleep event release signal is obtained. In particular, the threshold time may correspond to the before and after of a time interval on the basis of the timing that the sleep event release signal is obtained. And, moving information of the HMD device 100 moved in the first location information can be reflected to the second location information. In this case, the moving information may correspond to information on a movement of the user wearing the HMD device 100.

More specifically, the HMD device 100 can provide the user with the location information of when the sleeping state of the user is released. In this case, the HMD device 100 can provide the location information, which is changed according to the movement of the user wearing the HMD 100, to the user.

As an example, the HMD device 100 can move while the sleeping state of the user is maintained. In particular, the second location information may be different from the first location information. In case that the HMD device 100 detects the sleep event release signal, the HMD device 100 can provide the second location information to the user as a notification. By doing so, the HMD device 100 can provide the location information, which is changed due to the movement of the user, to the user.

And, as an example, the HMD device 100 may not move while the sleeping state of the user is maintained. More specifically, the HMD device 100 may not move due to such a reason as a traffic jam and the like. In particular, the first location information may be identical to the second location information. In this case, if the HMD device 100 detects the sleep event release signal, the HMD device 100 can provide time information to the user as a notification together with the second location information. In this case, the time information may correspond to information on time between obtainment of the sleep signal obtained by the HMD device 100 and obtainment of the sleep event release signal. In particular, if the sleeping state of the user is released, the HMD device 100 can provide the user with the time of maintaining the sleeping state while the location is not changed. And, as an example, in case that the HMD device 100 moves within a distance threshold, the HMD device 100 can provide the time information to the user as a notification together with the second location information. In this case, the distance threshold may correspond to a threshold distance used for determining whether the HMD device is moved and may have a prescribed error. More specifically, if the user wearing the HMD device 100 moves a little from a location based on the first location information, the HMD device 100 can provide a current location information and time information to the user.

And, the HMD device 100 can provide a notification including time information to the user irrespective of a movement of the HMD device 100. In particular, the HMD device 100 can provide the time information on time between obtainment of the sleep signal and obtainment of the sleep event release signal to the user 210 as a notification, by which the present specification may be non-limited.

And, the HMD device 100 can control a method of receiving location information. More specifically, the HMD device can provide information on the user 210, who has moved in a sleeping state, to the user as a notification. Hence, it is necessary for the HMD device 100 to determine whether the user 210 moves in a manner of controlling a timing that the location information is received.

As an example, the HMD device 100 can receive the location information at a specific point before the sleep signal is obtained. In particular, the HMD device 100 can receive information on a location before the user 210 is switched to the sleeping state as a first location information.

And, as an example, after receiving the sleep signal, the HMD device 100 can receive location information at a specific point before the sleep event release signal is obtained. In particular, the HMD device 100 can receive the first location information after the user 210 is switched to the sleeping state. By doing so, the HMD device 100 can provide a location change in the sleeping state of the user 210 as a notification. In particular, the HMD device 100 can receive the first location information at a specific point before the sleep event release signal is obtained.

And, when the sleep event release signal is obtained, the HMD device 100 can receive the second location information within threshold time. More specifically, after the sleeping state of the user 210 is released, the HMD device 100 can configure the location information, which is received within the threshold time, as the second location information. By doing so, the HMD device 100 can provide the location information of when the sleeping state of the user 210 is released to the user. And, as an example, the HMD device 100 can configure the location information, which is received within the threshold time, as the second location information before the sleep event release signal is obtained. In particular, the HMD device 100 configures the location information, which is received in the vicinity of the time of releasing the sleeping state of the user 210, as the second location information and can provide a notification to the user. By doing so, the HMD device 100 can provide the location information on the releasing of the sleeping state of the user 210.

And, as an example, referring to FIG. 4b, the HMD device 100 can receive the first location information within the threshold time when the sleep signal is obtained. And, the HMD device 100 can receive the second location information within the threshold time when the sleep event release signal is obtained.

More specifically, the HMD device 100 can configure location information, which is received within before and after of a prescribed time on the basis of timing on which the sleep signal is obtained, as the first location information. In particular, the HMD device 100 can configure the first location information as the location information of when the user 210 is switched to the sleeping state. And, the HMD device 100 can configure location information, which is received within before and after of a prescribed time on the basis of timing on which the sleep event release signal is obtained, as the second location information. In particular, the HMD device 100 can configure the second location information as the location information of when the sleeping state of the user 210 is released. By doing so, the HMD device 100 can deliver the location information on the movement in the sleeping state of the user 210 to the user 210.

And, the HMD device 100 can periodically receive the location information based on a predetermined period. In particular, the HMD device 100 can configure the periodically received location information as the first location information or the second location information.

FIG. 5a and FIG. 5b are diagrams of a method for a HMD device to provide a notification according to one embodiment of the present specification.

If the HMD device 100 obtains the sleep event release signal, the HMD device 100 can provide a notification on the second location information to the user 210. In this case, the HMD device 100 receives the second location information and can provide the notification on the received second location information to the user 210. In particular, the HMD device 100 can receive the second location information prior to the notification.

And, the HMD device 100 can provide the notification on the second location information as visual information using a display unit (not depicted). And, the HMD device 100 can provide the notification on the second location information as audio information using an audio unit (not depicted). More specifically, the second location information may correspond to a current location of the HMD device 100 or a location within an error range. In this case, if the user is released from the sleeping state, the HMD device 100 can provide information on a current location of the user. And, the notification may correspond to an operation of the HMD device providing information to the user, by which the present specification may be non-limited.

And, the HMD device 100 can provide a notification including at least one selected from the group consisting of location information, time information, schedule information, an alarm predetermined by the user. More specifically, the HMD device 100 can include various information in the notification provided to the user 210, by which the present specification may be non-limited.

As an example, referring to FIG. 5a and FIG. 5b, the HMD device 100 can provide the notification on the location information as visual information. In this case, the visual information can include at least one of text information and image information. More specifically, the HMD device 100 can provide the location information of the HMD device 100 to the user using a map image. Or, the HMD device 100 can provide current location information to the user as text information. And, as an example, the HMD device 100 can provide the notification to the user as audio information using audio information.

As a different example, the HMD device 100 can provide a notification on schedule information. In this case, the schedule information may correspond to information predetermined by the user or the HMD device 100. And, the schedule information may correspond to information based on current location information or predetermined destination information. And, the schedule information may correspond to information which is configured using at least one selected from the group consisting of a point of departure, a destination, a current location, and current time. More specifically, as an example, the HMD device 100 receives the second location information and can provide information on remaining time and a remaining distance as a notification based on destination information which is related to the second location information. By doing so, the HMD device 100 can provide the schedule information to the user 210 as the notification.

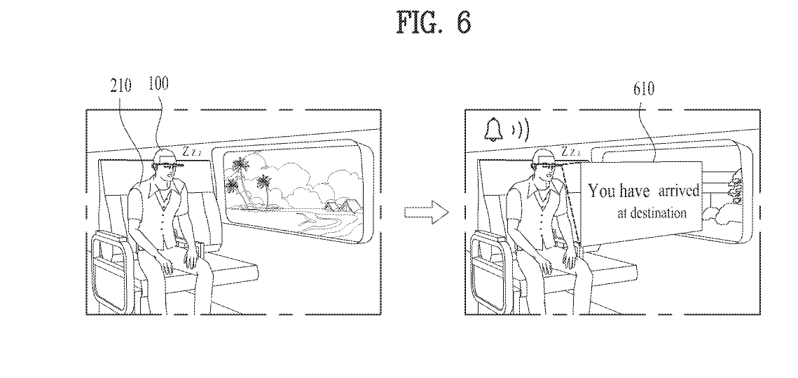

FIG. 6 is a diagram of a method for a HMD device to provide an alarm for a destination to a user according to one embodiment of the present specification.

The HMD device 100 can periodically receive location information based on a predetermined reception period. In this case, if received location information is identical to predetermined destination information, the HMD device 100 can deliver a feedback to a user 210.

More specifically, if a sleeping state of the user 210 lasts, the HMD device 100 can maintain a sleep event. In this case, if the sleeping state of the user 121 lasts in the long term, the user 210 may pass by a predetermined destination. The HMD device 100 can deliver a feedback on whether the user 210 arrives at a destination to the user via an alarm. In this case, the feedback can include at least one selected from the group consisting of visual feedback, audio feedback and tactile feedback. By doing so, the HMD device 100 can provide destination arrival information to the user.

In this case, the HMD device 100 can include the predetermined destination information. And, as an example, the HMD device 100 can provide a feedback to the user in the sleep event. And, as an example, if a destination is set, the HMD device 100 can provide a feedback to the user irrespective of the sleep event, by which the present specification may be non-limited.

As an example, referring to FIG. 6, the HMD device 100 can detect a sleeping state of the user 210. The HMD device 100 can maintain a sleep event in the sleeping state of the user 210. In this case, the HMD device 100 can receive location information based on a predetermined reception period. In this case, the reception period can be configured by the user or the HMD device 100. If a predetermined destination and the received location information are identical to each other, the HMD device 100 can provide a feedback to the user. In this case, the HMD device 100 can release the sleeping state of the user in a manner of providing an alarm to the user as audio information. And, as an example, the HMD 100 can release the sleeping state of the user in a manner of providing an alarm to the user as visual information, by which the present specification may be non-limited.

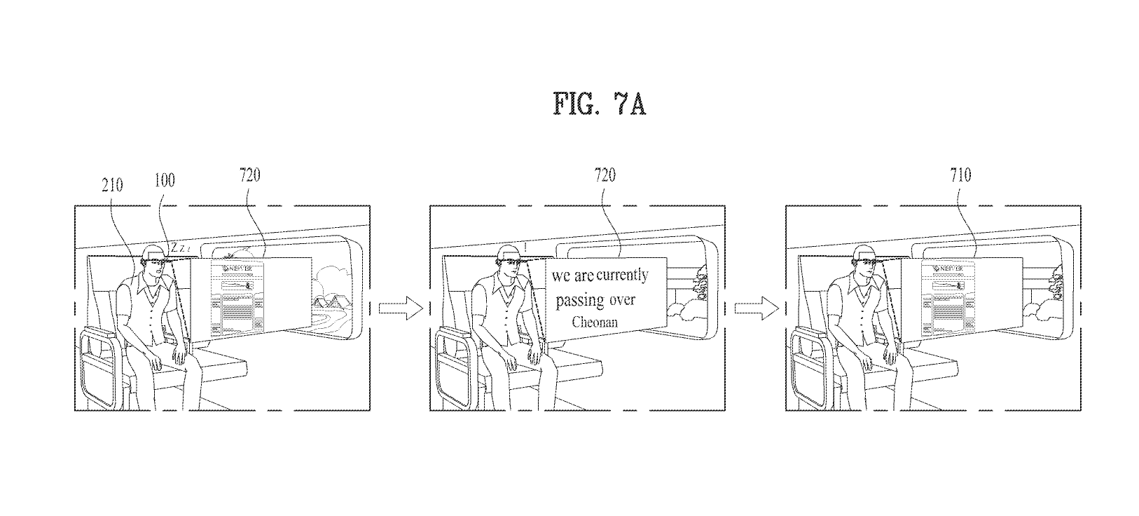

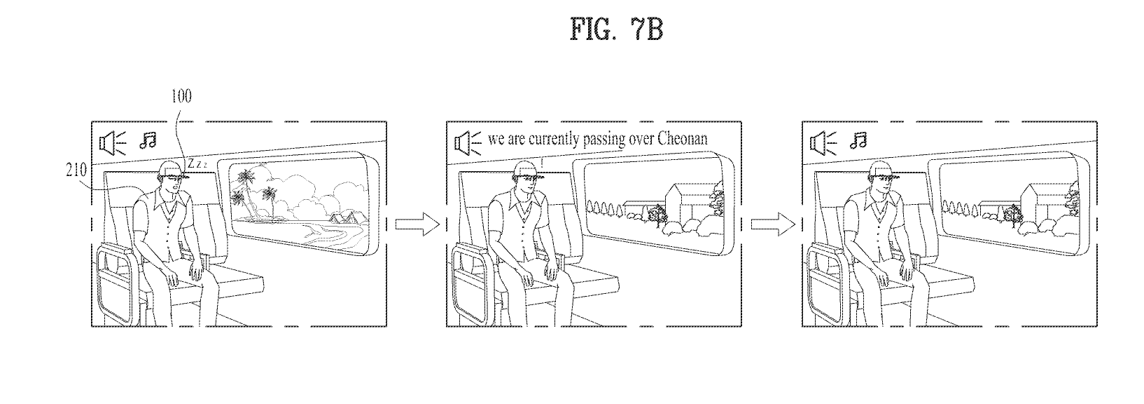

FIG. 7a and FIG. 7b are diagrams of a method for a HMD device to provide a notification prior to a different content according to one embodiment of the present specification.

The HMD device 100 can provide content to the user 210. In this case, the content can include at least one of visual information and audio information provided to the user via the HMD device 100. In particular, the content may correspond to information provided to the user via the HMD device 100, by which the present specification may be non-limited.

The HMD device 100 can provide the content to the user 210. In this case, the user may be switched to a sleeping state while the content is provided to the user. In particular, the HMD device 100 can consistently provide content information to the user in a sleep event state. In this case, as an example, if a sleep signal is obtained, the HMD device 100 can terminate the content which is provided in the sleep event state, by which the present specification may be non-limited.

When the content is consistently provided to the user in the sleep event state, if a sleep event release signal is obtained, the HMD device 100 can preferentially provide a notification on location information to the user. More specifically, if the sleeping state of the user 210 is released, the HMD device 100 can provide a notification to the user instead of the consistently provided content. In particular, the HMD device 100 can provide the notification to the user prior to a different content on timing that the sleep event release signal is obtained. In this case, as an example, the HMD device 100 provides the notification to the user from the timing that the sleep event release signal is obtained to a threshold time and may be then able to provide the content, which is used to be maintained, again. And, as an example, after the notification is provided to the user, the HMD device 100 can provide the content, which is used to be maintained, again based on a control input of the user, by which the present specification may be non-limited.

As an example, referring to FIG. 7a and FIG. 7b, the HMD device 100 can provide content of visual information to the user. In this case, the HMD device 100 can detect a sleeping state of the user 210. In this case, the HMD device 100 obtains a sleep signal and can set a sleep event. Thereafter, the HMD device 100 detects that the sleeping state of the user 210 is released and may be then able to obtain a sleep event release signal. In this case, when the sleep event release signal is obtained, the HMD device 100 can provide a notification on location information to the user instead of the content, which is used to be maintained. Thereafter, the HMD device 100 terminates the notification and may be then able to provide the content, which is previously maintained, to the user 210 again.

And, the provided content may correspond to audio information. More specifically, a sleep event can be set in a state that the audio information is provided to the user 210 using the HMD device 100. In this case, if a sleep event release signal is obtained, the HMD device 100 can provide a notification instead of a provided audio signal. Thereafter, the HMD device 100 terminates the notification and may be then able to provide the previously maintained content of audio information to the user 210 again.

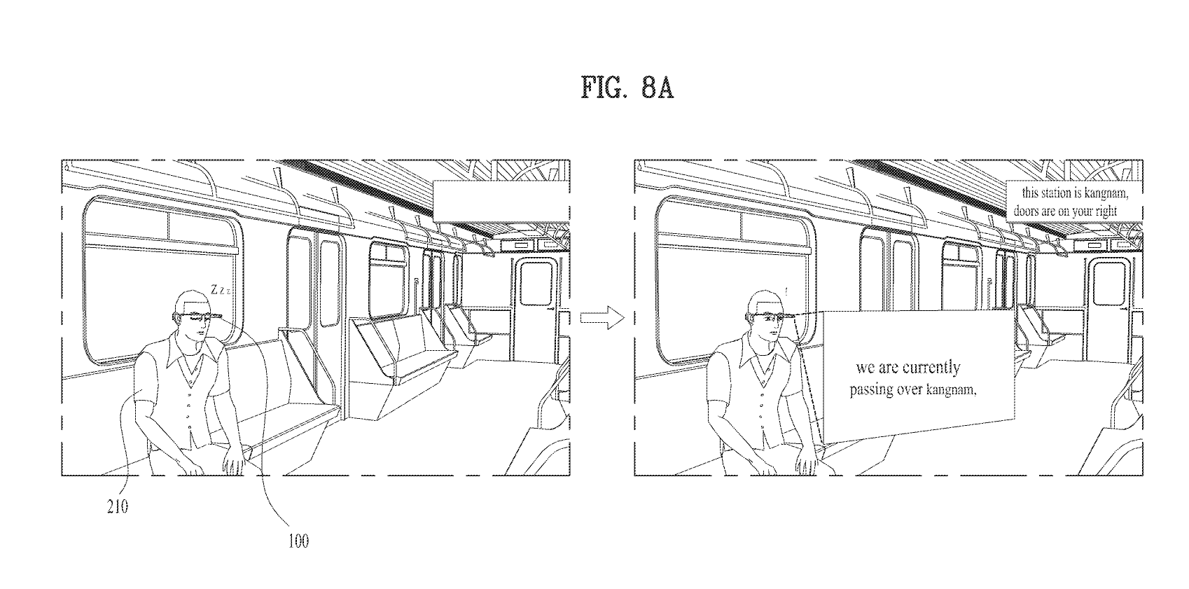

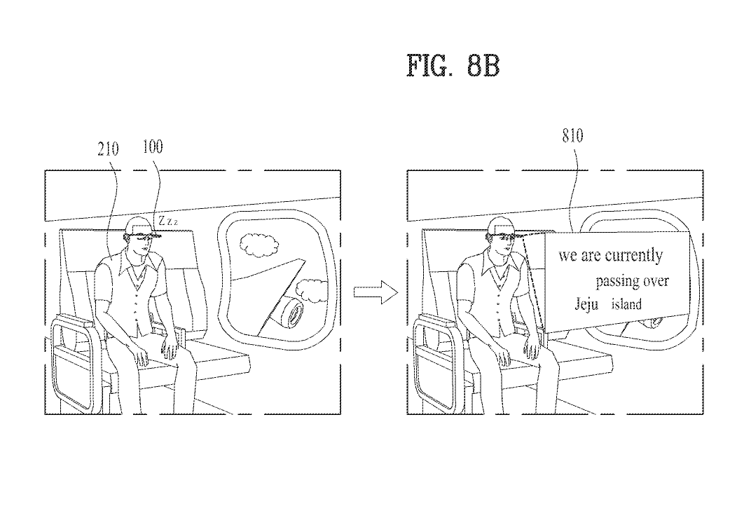

FIG. 8a and FIG. 8b are diagrams of a method for a HMD device to provide a notification based on a transportation means used by a user according to one embodiment of the present specification.

The HMD device 100 can provide a notification to a user based on a transportation means used by the user wearing the HMD device 100. More specifically, the HMD device 100 can set the notification and a location information reception period in consideration of the transportation means used by the user 210. As an example, if the user 210 uses a subway, the HMD device 100 can make the location information reception period to be short. And, the HMD device 100 can provide the notification to the user in a manner of setting an error for the location information to be small. And, as an example, if the user 210 uses a plane, the HMD device 100 can make the location information reception period to be long. And, the HMD device 100 can provide the notification to the user in a manner of setting the error for the location information to be big. In particular, the HMD device 100 can control the notification provided to the user by reflecting a characteristic of the transportation means used by the user. In this case, the HMD device 100 can control the notification via a control input inputted by the user wearing the HMD device 100 to select the transportation means.

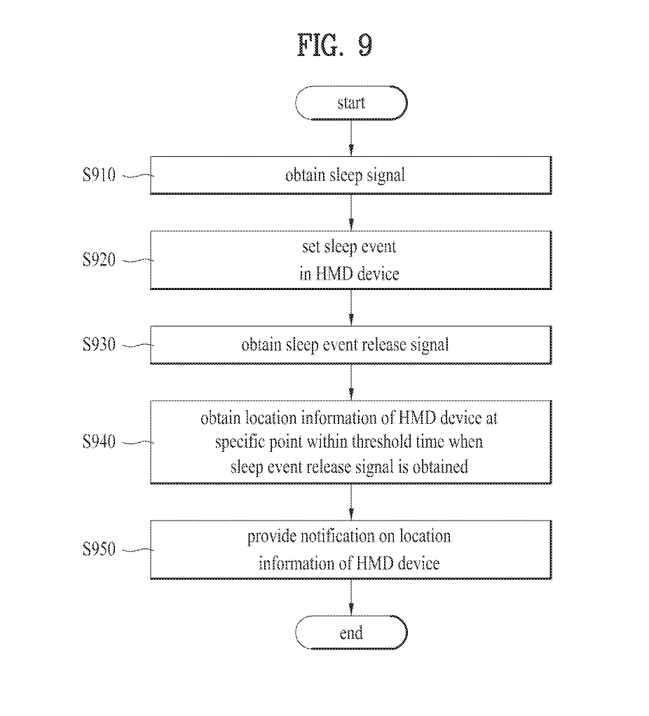

FIG. 9 is a flowchart of a controlling method for a HMD device to set a sleep event according to one embodiment of the present specification.

The HMD device can obtain a sleep signal [S910]. In this case, as mentioned earlier in FIG. 3a, if the HMD device 100 detects that a user is switched to a sleeping state, the HMD device can obtain the sleep signal. In this case, if the HMD device 100 detects a gaze of the user and detects that the detected gaze of the user is blocked for more than a threshold time, the HMD device can detect that the user is switched to the sleeping state. And, as an example, the HMD device 100 detects a bio-signal of the user. If the detected bio-signal of the user is matched with a predetermined bio-sleeping signal of the user, the HMD device can detect that the user is switched to the sleeping state. In particular, the HMD device 100 can obtain the sleep signal when the user is switched to the sleeping state.

Subsequently, the HMD device 100 can set a sleep event in the HMD device 100 [S920]. As mentioned earlier in FIG. 3a, the sleep event can be set when the sleep signal is obtained. More specifically, if the HMD device 100 obtains the sleep signal, the sleep event can be s in the HMD device 100. The sleep event may correspond to an event indicating that the user is in the sleeping state. In this case, if the sleeping state of the user lasts, the HMD device 100 can maintain the sleep event. As an example, if the state that the gaze of the user is blocked is maintained, the HMD device 100 can maintain the sleep event. As a different example, the HMD device can maintain the sleep event as long as the bio-signal of the user is matched with the bio-sleeping signal of the user.

Subsequently, the HMD device 100 can obtain a sleep event release signal [S930]. As mentioned earlier in FIG. 3a and FIG. 3b, if the sleeping state of the user is released, the HMD device 100 can obtain the sleep event release signal. In this case, as an example, if the HMD device 100 detects that the blocked state of the gaze of the user is released, the HMD device can obtain the sleep event release signal. And, the HMD device 100 can obtain the sleep event release signal when the user opens eyes and an additional operation of the user is detected only. As an example, if the blocked state of the user gaze is released and a rotating motion of the head of the user is further detected, the HMD device 100 can obtain the sleep event release signal. More specifically, if the gaze of the user is detected again and the head of the user is rotated more than angle threshold on the basis of a rotating axis, the HMD device 100 can obtain the sleep event release signal. In this case, the rotating motion of the head of the user may correspond to an operation that the user rotates the head of the user. And, the rotating axis can be configured on the basis of a center of the head of the user. In particular, the HMD device 100 detects a rotating angle of the head of the user wearing the HMD device 100 and can determine whether a detected angle is greater than the angle threshold. By doing so, the HMD device 100 can check that the user is released from the sleeping state.

Subsequently, the HMD device 100 can obtain location information of the HMD device 100 at a specific point within a threshold time when the sleep event release signal is obtained [S940]. As mentioned earlier in FIG. 4a and FIG. 4b, the HMD device 100 can receive second location information of the HMD device 100 at a specific point within the threshold time when the sleep event release signal is obtained. In this case, the threshold time may correspond to the before and after time interval on the basis of timing of obtaining the sleep event release signal. And, the second location information may correspond to location information which is changed from first location information due to a movement of the HMD device 100. More specifically, the HMD device 100 can provide location information of when the sleeping state of the user is released to the user. In this case, the HMD device 100 can provide the location information, which is changed due to the movement of the user wearing the HMD device 100, to the user.

Subsequently, the HMD device 100 can provide a notification on the location information of the HMD device 100 to the user [S950]. As mentioned earlier in FIG. 5a and FIG. 5b, the HMD device 100 can provide a notification including at least one selected from the group consisting of location information, time information, schedule information and an alarm predetermined by the user to the user. More specifically, the HMD device 100 can include various informations in the notification which is provided to the user 210, by which the present specification may be non-limited. And, the HMD device 100 can provide the notification on the location information as visual information. In this case, the visual information can include at least one of text information and image information. More specifically, the HMD device 100 can provide the location information of the HMD device 100 to the user using a map image. Or, the HMD device 100 can provide current location information to the user as text information. And, as an example, the HMD device 100 can provide a notification to the user as audio information using audio information. As a different example, the HMD device 100 can provide a notification on schedule information to the user. In this case, the schedule information may correspond to information predetermined by the user or the HMD device 100. And, the schedule information may correspond to information based on current location information or predetermined destination information. And, the schedule information may correspond to information configured using at least one selected from the group consisting of a point of departure, a destination, a current location, and a current time.

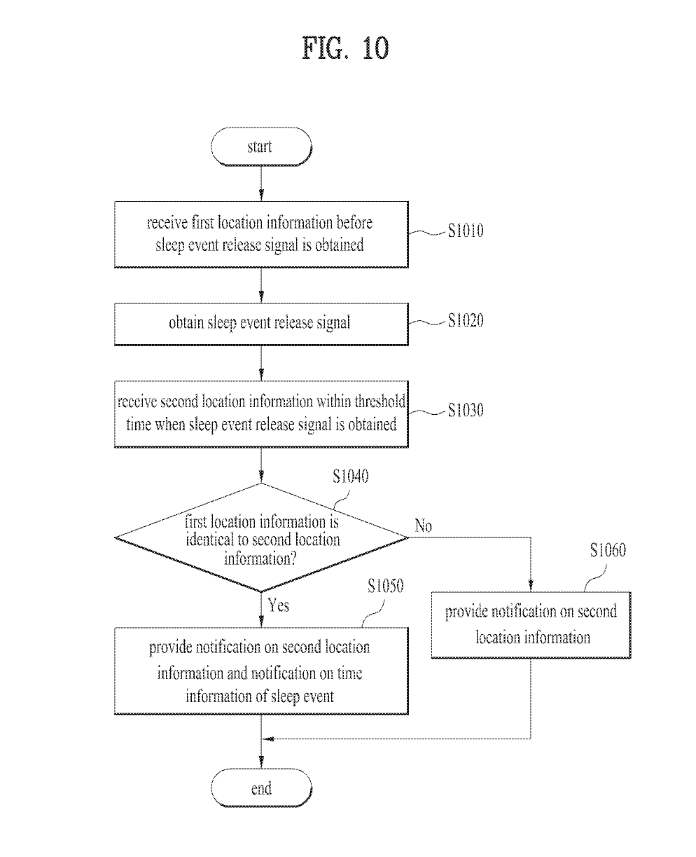

FIG. 10 is a flowchart of a controlling method for a HMD device to provide a notification on location information according to one embodiment of the present specification.

The HMD device 100 can receive first location information before a sleep event release signal is obtained [S1010]. As mentioned earlier in FIG. 4a and FIG. 4b, the HMD device 100 can receive location information at a specific point before a sleep signal is obtained. In particular, the HMD device 100 can receive a location prior to the user is switched to a sleeping state as the first location information. And, as an example, after the sleep signal is obtained, the HMD device 100 can receive the location information at a specific point before the sleep event release signal is obtained.

Subsequently, the HMD device 100 can obtain the sleep event release signal [S1020]. As mentioned earlier in FIG. 3a and FIG. 3b, the HMD device 100 can obtain the sleep event release signal when the sleeping state of the user is released. In this case, as an example, if the HMD device detects that blocked state of the user gaze is released, the HMD device 100 can obtain the sleep event release signal.

Subsequently, the HMD device 100 can receive second location information within a threshold time when the sleep event release signal is obtained [S1030]. As mentioned earlier in FIG. 4a and FIG. 4b, the HMD device 100 can receive the second location information within the threshold time when the sleep event release signal is obtained. More specifically, the HMD device 100 can configure the location information received within the threshold time as the second location information after the sleeping state of the user is released. The HMD device 100 configures the location information, which is received in the vicinity of timing of releasing the sleeping state of the user 210, as the second location information and may be then able to provide a notification to the user. By doing so, the HMD device 100 can provide the location information to the user in response to the release of the sleeping state of the user 210.

And, as an example, the HMD device 100 can receive the first location information within the threshold time when the sleep signal is obtained. And, the HMD device 100 can receive the second location information within the threshold time when the sleep event release signal is obtained.

More specifically, the HMD device 100 can configure location information, which is received within a prescribed time on the basis of the before and after a timing that the sleep signal is obtained, as the first location information. In particular, the HMD device 100 can configure the first location information as the location information of when the user 210 is switched to the sleeping state. And, the HMD device 100 can configure location information, which is received within a prescribed time on the basis of the before and after a timing that the sleep event release signal is obtained, as the second location information. In particular, the HMD device 100 can configure the second location information as the location information of when the sleeping state of the user 210 is released. By doing so, the HMD device 100 can deliver the location information to the user 210 in response to the movement of the user 210 in the sleeping state.

And, the HMD device 100 can periodically receive the location information based on a predetermined period. In particular, the HMD device 100 can configure the periodically received location information as the first location information or the second location information.

Subsequently, the HMD device 100 can determine whether the first location information is identical to the second location information [S1040]. As mentioned earlier in FIG. 5a and FIG. 5b, the HMD device 100 may not move while the sleeping state of the user is maintained. More specifically, the HMD device 100 may not move due to such a reason as a traffic jam and the like. In particular, the first location information may be identical to the second location information. And, as an example, if the HMD device 100 moves within a distance threshold, the HMD device can provide time information as a notification together with the second location information. In this case, the distance threshold may correspond to a threshold distance used for determining whether the HMD device 100 has moved or not and may have a prescribed error. More specifically, if the user 210 wearing the HMD device 100 moves a short distance from a location based on the first location information, the MID device 100 can provide current location information and the time information to the user.

Subsequently, if the first and the second location information are identical to each other, the HMD device 100 can provide a notification on the second location information and a notification on time information of a sleep event to the user [S1050]. As mentioned earlier in FIG. 5a and FIG. 5b, if the HMD device 100 detects the sleep event release signal, the HMD device 100 can provide time information as a notification together with the second location information. In this case, the time information may correspond to information on time until the sleep event release signal is obtained after the sleep signal is obtained by the HMD device 100. In particular, if the sleeping state of the user is released, the HMD device 100 can provide the time of maintaining the sleeping state of the user, which is maintained in a state that a location is not changed, to the user. And, the HMD device 100 can provide a notification including time information to the user irrespective of a movement of the HMD device 100. In particular, the HMD device 100 can provide time information on time ranging from timing of obtaining the sleep signal to timing of obtaining the sleep event release signal to the user as a notification, by which the present specification may be non-limited.

Subsequently, if the first location information is not identical to the second location information, the HMD device 100 can provide a notification on the second location information to the user [S1060]. As mentioned earlier in FIG. 4a and FIG. 4b, the HMD device 100 can receive the second location information of the HMD device 100 at a specific point within a threshold time when the sleep event release signal is obtained. In this case, the second location information may correspond to location information changed from the first location information due to the movement of the HMD device 100. More specifically, the HMD device 100 can provide location information of when the sleeping state of the user is released to the user. In this case, the HMD device 100 can provide the location information, which has changed due to the movement of the user wearing the HMD 100, to the user as the second location information.

For clarity of explanation, each diagram is explained in a manner of being divided. Yet, it is possible to design a new embodiment to implement the new embodiment by combining the embodiments, which are described in each of the diagrams. And, according to the necessity of those skilled in the art, designing a recording media readable by the computer, which has recorded a program for executing the previously explained embodiments, also belongs to a scope of a right.

A HMD device 100 according to the present specification and a method of controlling therefor may not limitedly apply to the composition and method of the aforementioned embodiments. The aforementioned embodiments may be configured in a manner of being selectively combined the whole of the embodiments or a part of the embodiments to achieve various modifications.

Meanwhile, a HMD device 100 according to the present specification and a method of controlling therefor can be implemented with a code readable by a processor in a recording media readable by the processor, which is equipped in a network device. The recording media readable by the processor may include all kinds of recording devices for storing data capable of being read by the processor. The examples of the recording media readable by the processor may include a ROM, a RAM, a magnetic tape, a floppy disc, an optical data storing device and the like. And, implementing in a form of a carrier wave such as a transmission via the internet and the like is also included. And, since the recording media readable by the processor are distributed to the computers connected by a network, codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

And, both an apparatus invention and a method invention are explained in the present specification and the explanation on both of the inventions can be complementally applied, if necessary.

What is claimed is:

1. A head mounted display (HMD) device, comprising:
a sensor unit configured to detect an input signal and deliver the detected input signal to a processor;
a location information receiving unit configured to receive location information, wherein the location information receiving unit configured to receive first location information of the HMD at a specific point before a sleep event release signal is obtained, and second location information of the HMD device at a specific point within a threshold time after the sleep event release signal is obtained, wherein movement information of the HMD device of the first location information is reflected on the second location information; and
the processor configured to control the location information receiving unit and the sensor unit,
wherein the processor is further configured to:
if a sleep signal is obtained, set a sleep event in the HMD device, wherein the sleep event indicates that a user of the HMD device is in a sleeping state,
if the sleep event release signal is obtained while the sleep event is set, provide a notification corresponding to the second location information of the HMD device.

2. The HMD device of claim 1, wherein the sensor unit is further configured to detect a gaze of the user of the HMD device.

3. The HMD device of claim 2, wherein the processor is further configured to:
if the detected gaze of the user is blocked for more than a reference time, obtain the sleep signal.

4. The HMD device of claim 3, wherein the processor is further configured to:
if the sleep event is set in the HMD device,
maintain the set sleep event when a blocked state of the gaze of the user is maintained, and
obtain the sleep event release signal when a release of the blocked state is detected.

5. The HMD device of claim 4, wherein the sensor unit is further configured to detect a rotating motion of a head of the user, and
wherein the processor is further configured to:
if the head of the user is rotating more than threshold angle on the basis of a rotating axis, obtain the sleep event release signal.

6. The HMD device of claim 1, wherein the sensor unit is further configured to detect whether the HMD device is worn or not.

7. The HMD device of claim 6, wherein the sensor unit is further configured to detect a bio-signal of the user while the HMD device is worn by the user, and
wherein if the bio-signal of the user is matched with a bio-sleeping signal, obtain the sleep signal.

8. The HMD device of claim 7, wherein the processor is further configured to:
if the sleep event is set in the HMD device,
maintain the sleep event when the bio-signal of the user is matched with the bio-sleeping signal, and
obtain the sleep event release signal when the bio-signal of the user is not matched with the bio-sleeping signal.

9. The HMD device of claim 1, wherein the location information receiving unit is further configured to:
receive the first location information of the HMD device at a specific point within the threshold time when the sleep signal is obtained, and
receive the second location information of the HMD device at a specific point within the threshold time when the sleep event release signal is obtained.

10. The HMD device of claim 1, wherein the location information receiving unit is further configured to periodically receive the location information based on a reception period.

11. The HMD device of claim 10, wherein the processor is further configured to:
if the received location information is identical to a predetermined destination information in a state of the sleep event, deliver a feedback to the user.

12. The HMD device of claim 1, wherein the processor is further configured to:
if the first location information of the HMD device is identical to the second location information of the HMD device, provide a notification on continuous time information of the sleep event.

13. The HMD device of claim 12, wherein the continuous time information of the sleep event corresponds to information on time between sleep signal and sleep event release signal.

14. The HMD device of claim 1, wherein the processor is further configured to:
provide the notification on the second location information of the HMD device prior to a different content when the sleep event release signal is obtained.

15. The HMD device of claim 1, wherein the processor is further configured to:
provide a notification on schedule information when the sleep event release signal is obtained.

16. The HMD device of claim 15, wherein the processor is further configured to:
provide the schedule information based on the second location information and information on a predetermined destination.

17. The HMD device of claim 16, wherein the schedule information includes at least one of information on a remaining distance from the second location information to the predetermined destination and information on remaining time.

18. The HMD device of claim 1, further comprising a display unit configured to display visual information,
wherein the processor is further configured to provide the notification using the display unit.

19. The HMD device of claim 1, further comprising an audio unit configured to output audio information,
wherein the processor is further configured to provide the notification using the audio unit.

20. A method of controlling a HMD device, comprising the steps of:
if a sleep signal is obtained, setting a sleep event in the HMD device, wherein the sleep event indicates that a user of the HMD device is in a sleeping state;
receiving first location information;
obtaining a sleep event release signal;
receiving second location information, wherein movement information of the HMD device of the first location information is reflected on the second location information; and
providing a notification on the second location information of the HMD device.
